(19) United States
(12) Patent Application Publication
(10) Pub. No.: US 2010/0150270 A1
(43) Pub. Date: Jun. 17, 2010

(54) SIGNAL PROCESSING CIRCUIT AND RECEIVER USING THE SAME

(75) Inventors: Masanori Furuta, Odawara-shi (JP); Takafumi Yamaji, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/558,765

(22) Filed: Sep. 14, 2009

(30) Foreign Application Priority Data
Dec. 17, 2008 (JP) 2008-321375

(51) Int. Cl. H04L 27/22

(52) U.S. Cl. 375/322

(57) ABSTRACT

A signal processing circuit includes a decimation filter which down-samples over-sampled first three-phase digital signals to obtain second three-phase digital signals, and a converter which subjects the second three-phase digital signals to a three-phase to IQ conversion, and obtains orthogonal digital signals.

### CROSS-REFERENCE TO RELATED APPLICATIONS

This application is based upon and claims the benefit of priority from prior Japanese Patent Application No. 2008-321375, filed Dec. 17, 2008, the entire contents of which are incorporated herein by reference.

### BACKGROUND OF THE INVENTION

1. Field of the Invention

The present invention relates to a signal processing circuit performing down-sampling and 3-phase to IQ conversion on over-sampled 3-phase signals to obtain an orthogonal signal, and a receiver using the signal processing circuit.

2. Description of the Related Art

Mixers inside a receiver perform down conversion in which a received radio signal is multiplied by a local signal to obtain a baseband signal. To obtain an I (In-phase) signal and a Q (Quadrature-phase) signal (both the I signal and the Q signal are hereinafter also referred to as orthogonal signals), the receiver uses the mixer for 1 signal generation to multiply the local signal by the radio signal, while using the mixer for Q signal generation to multiply the radio signal by a signal obtained by shifting the phase of the local signal by π/2.

Furthermore, Japanese Patent No. 4181188 discloses a 3-phase mixer multiplying a radio signal by 3-phase local signals having phases different from one another by 2π/3. The 3-phase mixer allows the receiver to be configured to have a reduced area and reduced power consumption.

When the 3-phase mixer is actually used inside the receiver, 3-phase baseband signals need to be converted into orthogonal signals. The conversion of the 3-phase signals into the orthogonal signals can theoretically be achieved either by analog signal processing or by digital signal processing. However, in view of the noise resistance, process variation resistance, and circuit area and power consumption of a 3-phase to IQ converter performing the 3-phase to IQ conversion, the above-described conversion is preferably carried out by the digital signal processing. Furthermore, with a circuit configuration (what is called a direct conversion) in which a 3-phase mixer and an over-sampling ADC (Analog-to-Digital Converter) are coupled directly to each other as in the case of a receiver described in T. Yamada, et al., “A Direct Conversion Receiver Adopting Balanced Three-Phase Analog System,” IEEE Int. Symp. On VLSI circuit, pp. 36-37, 2007 (hereinafter simply referred to as related art), the above-described 3-phase to IQ conversion inevitably needs to be performed in a digital region.

When the 3-phase to IQ conversion is performed in the digital region, 3-phase digital signals need to be multiplied by a predetermined conversion coefficient. The conversion coefficient is a value that cannot be expressed in finite binary number. Thus, the digital expression of the conversion coefficient may result in a quantization error. The quantization error may cause an image signal component of a desired signal component to be generated, degrading the reception performance of the receiver. In other words, to improve the reception performance of the receiver, the conversion coefficient needs to have an increased word length (bit length) to inhibit the possible quantization error.

Here, in the receiver described in the related art, it is assumed that the 3-phase to IQ converter is coupled directly to the over-sampling ADC. The over-sampling ADC has a relatively low resolution and a relatively high sample rate. Specifically, the sample rate of the over-sampling ADC is about several tens of to several hundred times as high as a baseband frequency band. That is, the 3-phase to IQ converter coupled directly to the over-sampling ADC needs to deal with digital signals having a high sample rate and a large word length (in order to reduce degradation of the reception performance caused by a quantization error in the conversion coefficient). The configuration in which the 3-phase to IQ converter is coupled directly to the over-sampling ADC is not preferable in terms of circuit area and power consumption. However, no alternative configuration is disclosed in the related art.

### BRIEF SUMMARY OF THE INVENTION

According to an aspect of the invention, there is provided a signal processing circuit comprising: a decimation filter which down-samples over-sampled first three-phase digital signals, and obtains second three-phase digital signals; and a converter which subjects the second three-phase digital signals to a three-phase to IQ conversion to obtain orthogonal digital signals.

According to another aspect of the invention, there is provided a signal processing circuit comprising: a first decimation filter which down-samples over-sampled first three-phase digital signals to obtain second three-phase digital signals; a converter which subjects the second three-phase digital signals to a three-phase to IQ conversion, and obtains first orthogonal digital signals; and a second decimation filter which down-samples the first orthogonal digital signal to obtain second orthogonal digital signals.

### BRIEF DESCRIPTION OF THE SEVERAL VIEWS OF THE DRAWING

FIG. 1 is a block diagram showing a signal processing circuit according to a first embodiment;

FIG. 2 is a time chart showing a control clock input to a first signal processing circuit;

FIG. 3 is a block diagram showing a signal processing circuit according to a second embodiment;

FIG. 4 is a block diagram showing a specific example of the signal processing circuit according to the second embodiment;

FIG. 5 is a graph showing the relationship between the word length of a conversion coefficient used for a 3-phase to IQ conversion and an image rejection ratio;

FIG. 6 is a graph showing the power spectrum of orthogonal digital signals obtained by the 3-phase to IQ conversion when the conversion coefficient used for the 3-phase to IQ conversion has 8 bits;

FIG. 7 is a block diagram showing a signal processing circuit according to a third embodiment;

FIG. 8 is a block diagram showing a signal processing circuit according to a fourth embodiment;

FIG. 9 is a block diagram showing a receiver according to a fifth embodiment; and

FIG. 10 is a block diagram showing a receiver according to a sixth embodiment.

### DETAILED DESCRIPTION OF THE INVENTION

Embodiments of the present invention will be described below.

### First Embodiment

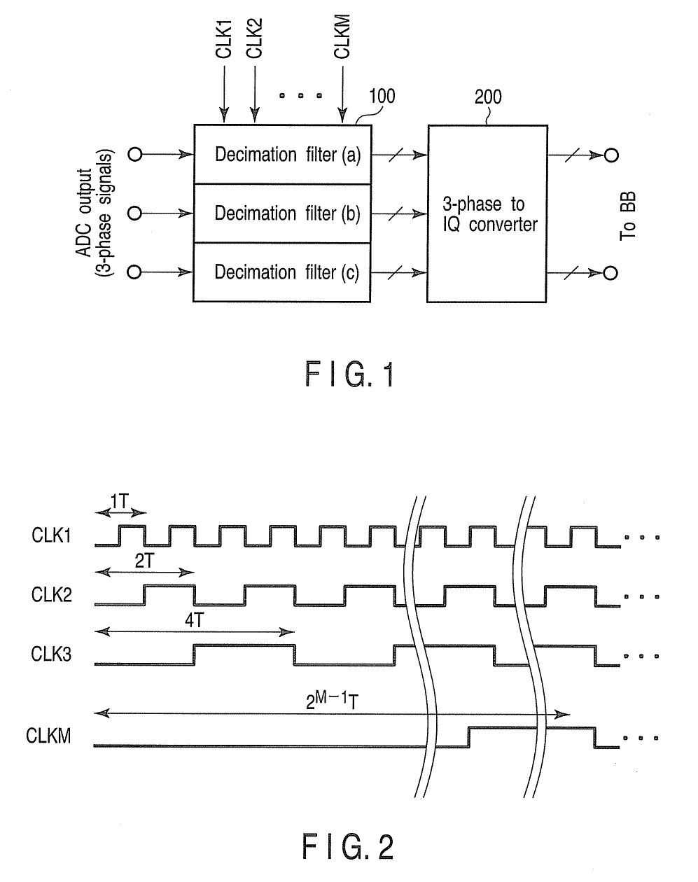

As shown in FIG. 1, a signal processing circuit according to a first embodiment of the present invention has a decimation filter 100 and a 3-phase to IQ converter 200.

The decimation filter 100 includes, for example, a sinc filter and a down sampler. A 3-phase digital signal from an over-sampling ADC (not shown) is input to the decimation filter 100. The decimation filter 100 performs filter processing on the 3-phase digital signals to obtain 3-phase digital signals of at most a baseband frequency band. The filter processing by the decimation filter 100 reduces the sample rate of the input 3-phase digital signals (down-sampling), while increasing word length. The decimation filter 100 inputs the down-sampled 3-phase digital signals to a 3-phase to IQ converter 200.

For example, M (in the description below, M denotes a natural number) control clocks such as those shown in FIG. 2 are input to the decimation filter 100. The first control clock CLK1 is a pulse wave with a period T. The second control clock CLK2 is a pulse wave with a period 2T (the pulse wave obtained by dividing the frequency of the first control clock CLK1 by two). The third control clock CLK3 is a pulse wave with a period 4T (the pulse wave obtained by dividing the frequency of the first control clock CLK1 by 2²). The Mth control clock is a pulse wave with a period 2^{M-1}T (the pulse wave obtained by dividing the frequency of the first control clock CLK1 by 2^{M-1}). When the control clock shown in FIG. 2 is applied, the decimation filter 100 performs filter processing in which the sample rate of the input 3-phase digital signal is multiplied by ½^{M}.

The 3-phase to IQ converter 200 uses a digital conversion coefficient expressed by a predetermined word length to convert 3-phase digital signals from the decimation filter 100 into orthogonal digital signals. The 3-phase to IQ converter 200 inputs the orthogonal digital signals to a baseband processing unit (not shown).

An image component attributed to a quantization error in the digital conversion coefficient used by the 3-phase to IQ converter 200 is quantatively evaluated.

First, an input signal x(t) from the 3-phase to IQ converter 200 is expressed by:

$$\begin{matrix}x ( t ) = {V}_{a} + {V}_{b} + {V}_{c} \\ = A cos ( {ω}_{t} + {φ}_{1} ) + B cos ( {ω}_{t} + {φ}_{2} + \frac{2}{3} π ) + \\ C cos ( {ω}_{t} + {φ}_{3} - \frac{2}{3} π )\end{matrix} \qquad ( 1 )$$

In Expression (1), Va denotes a signal with an amplitude A and an initial phase Φ1. Vb denotes a signal obtained by advancing a signal with an amplitude B and an initial phase Φ2 by 2π/3. Vc denotes a signal obtained by delaying a signal with an amplitude C and an initial phase Φ3 by 2π/3. The 3-phase digital signals Va, Vb, and Vc all have an angular frequency ωt. Applying the Euler's formula to Expression (1) results in:

$$x ( t ) = A \frac{{e}^{{jω}_{t}} {e}^{{jφ}_{1}} + {e}^{- {jω}_{t}} {e}^{- {jφ}_{1}}}{2} + B \frac{- {e}^{{jω}_{t}} {e}^{{jφ}_{2}} {e}^{jπ / 6} + {e}^{- {jω}_{t}} {e}^{- {jφ}_{2}} {e}^{- jπ / 6}}{2 j} + C \frac{ {e}^{{jω}_{t}} {e}^{{jφ}_{3}} {e}^{- jπ / 6} - {e}^{- {jω}_{t}} {e}^{- {jφ}_{3}} {e}^{jπ / 6}}{2 j} \qquad ( 2 )$$

According to Expression (2), the desired signal component and image signal component of the input signal x(t) are expressed by Expressions (3) and (4), respectively.

$$\begin{matrix}{x ( t )}_{De} = {e}^{{jω}_{t}} ( \begin{matrix}\frac{A}{2} {e}^{{jφ}_{1}} - \frac{B {e}^{{jφ}_{2}} + C {e}^{{jφ}_{3}}}{2} sin \frac{π}{6} + \\ j \frac{B {e}^{{jφ}_{2}} - C {e}^{{jφ}_{3}}}{2} cos \frac{π}{6}\end{matrix} ) & ( 3 ) \\ {x ( t )}_{Im} = {e}^{- {jω}_{t}} ( \begin{matrix}\frac{A}{2} {e}^{- {jφ}_{1}} - \frac{B {e}^{- {jφ}_{2}} + C {e}^{- {jφ}_{3}}}{2} sin \frac{π}{6} + \\ j \frac{B {e}^{- {jφ}_{2}} + C {e}^{- {jφ}_{3}}}{2} cos \frac{π}{6}\end{matrix} ) & ( 4 )\end{matrix}$$

Here, in Expression (2), it is assumed that the 3-phase digital signals Va, Vb, and Vc have the same amplitude (A=B=C=Am) and the same initial phase (Φ1=Φ2=Φ3=Φ). That is, to convert the 3-phase digital signals Va, Vb, and Vc into orthogonal digital signals VI and VQ, the 3-phase to IQ converter 200 may perform, for example, a matrix operation shown in:

$$[ \begin{matrix}{V}_{I} \\ {V}_{Q}\end{matrix} ] = [ \begin{matrix}\frac{2}{3} & - \frac{1}{3} & - \frac{1}{3} \\ 0 & - \frac{1}{\sqrt{3}} & \frac{1}{\sqrt{3}}\end{matrix} ] [ \begin{matrix}{V}_{a} \\ {V}_{b} \\ {V}_{c}\end{matrix} ] \qquad ( 5 )$$

Here, the input signal x(t) can be expressed as shown in Expression (6) using the orthogonal digital signals VI and VQ.

x(t)=V_{I}+jV_{Q} (6)

According to Expressions (2) and (5), VI and VQ are expressed by Expressions (7) and (8), respectively.

$$\begin{matrix}{V}_{I} = {e}^{{jω}_{t}} \{ \frac{{A}_{m}}{3} {e}^{jφ} + \frac{1}{12} ( {A}_{m} {e}^{jφ} + {A}_{m} {e}^{jφ} ) \} + {e}^{- {jω}_{t}} \{ \frac{{A}_{m}}{3} {e}^{- jφ} + \frac{1}{12} ( {A}_{m} {e}^{- jφ} + {A}_{m} {e}^{- jφ} ) \} & ( 7 ) \\ {V}_{Q} = {je}^{{jω}_{t}} \{ - \frac{1}{4} ( {A}_{m} {e}^{jφ} + {A}_{m} {e}^{jφ} ) \} + {je}^{- {jω}_{t}} \{ \frac{1}{4} ( {A}_{m} {e}^{- jφ} + {A}_{m} {e}^{- jφ} ) \} & ( 8 )\end{matrix}$$

According to Expression (6) to Expression (8), the input signal x(t) subjected to a 3-phase to IQ conversion based on Expression (5) is expressed by:

$$x ( t ) = {e}^{{jω}_{t}} \{ \begin{matrix}\frac{{A}_{m}}{3} {e}^{jφ} + \frac{1}{12} ( {A}_{m} {e}^{jφ} + {A}_{m} {e}^{jφ} ) + \\ \frac{1}{4} ( {A}_{m} {e}^{jφ} + {A}_{m} {e}^{jφ} )\end{matrix} \} + {e}^{- {jω}_{t}} \{ \begin{matrix}\frac{{A}_{m}}{3} {e}^{- jφ} + \frac{1}{12} ( {A}_{m} {e}^{- jφ} + {A}_{m} {e}^{- jφ} ) - \\ \frac{1}{4} ( {A}_{m} {e}^{- {jφ}_{i}} + {A}_{m} {e}^{- jφ} )\end{matrix} \} \qquad ( 9 )$$

Thus, as shown in Expression (10), the input signal x(t) ideal subjected to the ideal three phase-orthogonal conversion (that is, the 3-phase to IQ conversion preventing a possible quantization error) contains no image signal component.

x(t)_{ideal}=Aₘe^{jω}t (10)

However, each of the elements of the conversion coefficient matrix in Expression (5) actually involves a quantization error. That is, the 3-phase to IQ converter 200 actually performs a matrix operation shown in Expression (11) to convert the 3-phase digital signals Va, Vb, and Vc into orthogonal digital signals VI′ and VQ′.

$$[ \begin{matrix}{V}_{I}^{′} \\ {V}_{Q}^{′}\end{matrix} ] = [ \begin{matrix}\frac{2}{3} + {q}_{1} & - \frac{1}{3} + {q}_{2} & - \frac{1}{3} + {q}_{2} \\ 0 & - \frac{1}{\sqrt{3}} - {q}_{3} & \frac{1}{\sqrt{3}} + {q}_{3}\end{matrix} ] [ \begin{matrix}{V}_{a} \\ {V}_{b} \\ {V}_{c}\end{matrix} ] \qquad ( 11 )$$

In Expression (11), q1, q2, and q3 denote quantization errors of ⅔, −⅓, and 1/√3, respectively.

It is assumed that in Expression (2), the 3-phase digital signals Va, Vb, and Vc have the same amplitude (A=B=C=Am) and the same initial phase (Φ1=Φ2=Φ3=Φ) as described above. Then, according to Expressions (2) and (11), VI′ and VQ′ are expressed by Expressions (12) and (13), respectively.

$$\begin{matrix}{V}_{I}^{′} = {e}^{{jω}_{t}} \{ \begin{matrix}\frac{{A}_{m}}{3} {e}^{jφ} + \frac{{A}_{m}}{6} {e}^{jφ} + \\ \frac{{A}_{m}}{2} {q}_{1} {e}^{jφ} + \frac{{A}_{m}}{2} {q}_{2} {e}^{jφ}\end{matrix} \} + {e}^{- {jω}_{t}} \{ \begin{matrix}\frac{{A}_{m}}{3} {e}^{- jφ} + \frac{{A}_{m}}{6} {e}^{- jφ} + \\ \frac{{A}_{m}}{2} {q}_{1} {e}^{- jφ} + \frac{{A}_{m}}{2} {q}_{2} {e}^{- jφ}\end{matrix} \} & ( 12 ) \\ {V}_{Q}^{′} = {je}^{{jω}_{t}} \{ - \frac{{A}_{m}}{2} {e}^{jφ} - \frac{{A}_{m}}{2 \sqrt{3}} {q}_{3} {e}^{jφ} \} + {je}^{- {jω}_{t}} \{ \frac{{A}_{m}}{2} {e}^{- jφ} + \frac{{A}_{m}}{2 \sqrt{3}} {q}_{3} {e}^{- jφ} \} & ( 13 )\end{matrix}$$

According to Expressions (6), (12), and (13), the input signal x(t) subjected to a 3-phase to IQ conversion based on Expression (11) is expressed by:

$$\begin{matrix}{x ( t )}_{real} = {e}^{{jω}_{t}} \{ \begin{matrix}\frac{{A}_{m}}{2} {e}^{jφ} + \frac{{A}_{m}}{2} {q}_{1} {e}^{jφ} + \frac{{A}_{m}}{2} {q}_{2} {e}^{jφ} + \\ \frac{{A}_{m}}{2} {e}^{jφ} + \frac{{A}_{m}}{2 \sqrt{3}} {q}_{3} {e}^{jφ}\end{matrix} \} + \\ {e}^{- {jω}_{t}} \{ \begin{matrix}\frac{{A}_{m}}{2} {e}^{- jφ} + \frac{{A}_{m}}{2} {q}_{1} {e}^{- jφ} + \frac{{A}_{m}}{2} {q}_{2} {e}^{- jφ} - \\ \frac{{A}_{m}}{2} {e}^{- jφ} - \frac{{A}_{m}}{2 \sqrt{3}} {q}_{3} {e}^{- jφ}\end{matrix} \} \\ = {e}^{{jω}_{t}} \{ \begin{matrix}{A}_{m} {e}^{jφ} + \frac{{A}_{m}}{2} {q}_{1} {e}^{jφ} + \\ \frac{{A}_{m}}{2} {q}_{2} {e}^{jφ} + \frac{{A}_{m}}{2 \sqrt{3}} {q}_{3} {e}^{jφ}\end{matrix} \} + \\ {e}^{- {jω}_{t}} \{ \frac{{A}_{m}}{2} {q}_{1} {e}^{- jφ} + \frac{{A}_{m}}{2} {q}_{2} {e}^{- jφ} - \frac{{A}_{m}}{2 \sqrt{3}} {q}_{3} {e}^{- jφ} \}\end{matrix} \qquad ( 14 )$$

Thus, as shown in Expression (14), the input signal x(t) real subjected to the real 3-phase to IQ conversion (that is, the conversion containing a quantization error) contains an image signal component attributed to the quantization error. Furthermore, the desired signal component is also affected by the quantization error. Specifically, for example, as shown in FIG. 6, an image signal component of the desired signal is generated in the power spectrum of the orthogonal digital signals resulting from the 3-phase to IQ conversion. In FIG. 6, the word length of the conversion coefficient is 8 bits. The quantization errors q1, q2, and q3 are reduced by increasing the word length of the conversion coefficient. Thus, the appropriate word length is desirably set in view of the tradeoff between reception performance required for the signal processing circuit according to the present embodiment and an increase in circuit area and in power consumption associated with an increase in word length. That is, the 3-phase to IQ converter 200 essentially needs to perform signal processing for a somewhat large word length. When the 3-phase to IQ converter 200 is placed after the decimation filter 100, the sample rate decreases sharply in spite of a slight increase in the word length to be dealt with, compared to the case where the 3-phase to IQ converter 200 is coupled directly to the over-sampling ADC (not shown). As a result, the power consumption of the 3-phase to IQ converter 200 can be reduced.

As described above, in the signal processing circuit according to the present embodiment, the decimation filter provided before the 3-phase to IQ converter down-samples 3-phase digital signals from the over-sampling ADC. Thus, the signal processing circuit according to the present embodiment enables a reduction in the operation speed of the 3-phase to IQ converter and can thus be configured to consume only low power.

### Second Embodiment

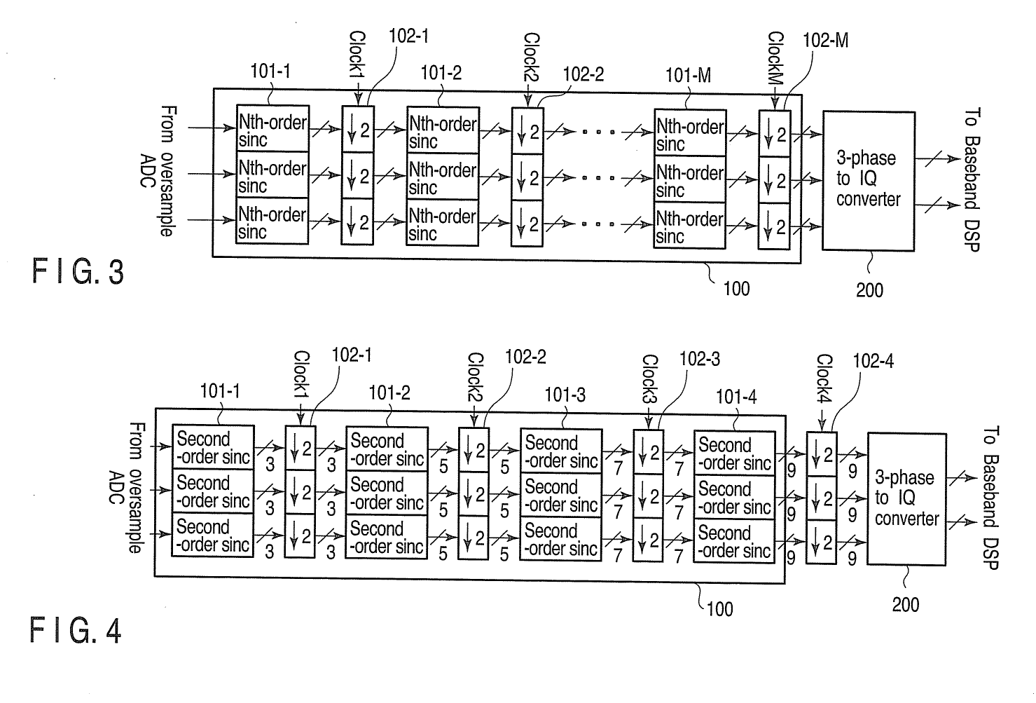

As shown in FIG. 3, a signal processing circuit according to a second embodiment of the present invention corresponds to the signal processing circuit shown in FIG. 1 described above and in which the decimation filter 100 includes a plurality of cascaded decimation filters having a low down sample rate. In the description below, in FIG. 3, the same components as those in FIG. 1 are denoted by the same reference numerals. Differences from FIG. 1 will be mainly described.

In FIG. 3, the decimation filter 100 is composed of M decimation filters each composed of an Nth-order sinc filter (in the description below, N denotes a natural number) and a down sampler; the M decimation filers are cascaded together. A configuration in which a plurality of decimation filters each composed of a comb filter such as sinc filter and a down sampler are cascaded together is disclosed as a CIC (Cascade Integrator Comb) decimation filter in, for example, “E. B. Hogenauer, “An Economical Class of Digital Filters for Decimation and Interpolation,” IEEE Trans. Acoustics, Speech and Signal Processing, vol. ASSP-20, No. 2, pp. 155-162, April 1981”. The CIC decimation filter is a circuit configuration for minimizing the circuit scale of the decimation filter. Thus, the decimation filer 100 configured as the CIC decimation filter is expected to have a reduced circuit area.

The first decimation filter is composed of an Nth-order sinc filter 101-1 and a down sampler 102-1. The Nth-order sinc filter 101-1 performs filter processing for removing a folding noise component from 3-phase digital signals input by the over-sampling ADC. In general, a sinc filter with a higher order N allows the folding noise component to be more effectively removed but has an increased circuit area and increased power consumption. The down sampler 102-1 is controlled by the above-described first control clock CLK1 to perform down sample processing for reducing the sample rate of the 3-phase digital signals filtered by the Nth-order sinc filter 101-1, to half.

The second decimation filter is composed of an Nth-order sinc filter 101-2 and a down sampler 102-2. The Nth-order sinc filter 101-2 performs filter processing for removing a folding noise component from a 3-phase digital signal input by the down sampler 102-1. The down sampler 102-2 is controlled by the above-described second control clock CLK2 to perform a down sampling process for reducing the sample rate of the 3-phase digital signal filtered by the Nth-order sinc filter 101-2, to half.

The Mth decimation filter is composed of an Nth-order sinc filter 101-M and a down sampler 102-M. The Nth-order sinc filter 101-M performs filter processing for removing a folding noise component from a 3-phase digital signal input by the down sampler 102-(M−1). The down sampler 102-M is controlled by the above-described Mth control clock CLKM to perform a down sampling process for reducing the sample rate of the 3-phase digital signal filtered by the Nth-order sinc filter 101-M, to half. The down sampler 102-M inputs the down-sampled 3-phase digital signal to the 3-phase to IQ converter 200.

For simplification of description, it is assumed that in FIG. 3, N=2 and M=4 as shown in FIG. 4. Furthermore, in FIG. 4, an input signal from the over-sampling ADC (not shown) has a word length of 1 bit. The table shown below shows the down sample rate of an output signal from each of the stages of the decimation filter 100 based on the word length of the output signal from the stage and the sample rate of the input signal from the over-sampling ADC.

TABLE 1

| | | Down sample |
|---|---|---|
| Stage | Word length | rare |
| 1 | 3 | 2 |
| 2 | 5 | 4 |
| 3 | 7 | 8 |
| 4 | 9 | 16 |

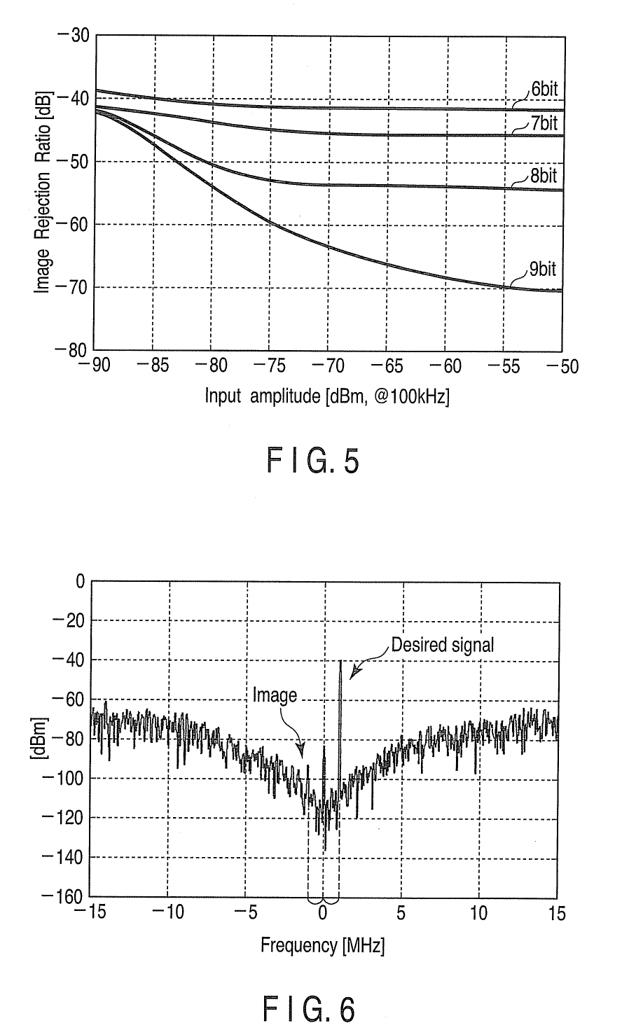

FIG. 5 shows the relationship between the word length of the conversion coefficient used by the 3-phase to IQ converter 200 and an image rejection ratio; the relationship is observed when in FIG. 4, the sample rate of the input signal from the over-sampling ADC (not shown) is set to 320 MHz. In FIG. 6, the desired signal has a frequency of 100 kHz and a quantization noise floor of −110 dbm. FIG. 5 indicates that when the input signal has a somewhat large amplitude, an increased word length of the conversion coefficient increases the image rejection ratio. For example, when the input signal has an amplitude of −50 dbm, there is a difference of as much as about 30 db between the case where the conversion coefficient has a word length of 6 bits and the case where the conversion coefficient has a word length of 9 bits. In FIG. 5, a relatively small amplitude of the input signal generally reduces the image rejection ratio regardless of the word length of the conversion coefficient. This is because the small amplitude relatively increases the impact of the quantization noise.

A power consumption reduction effect exerted by the signal processing circuit in FIG. 4 will be discussed below.

As an index for power consumption, the sum of the number of down samplers multiplied by the sample rate in each stage of the decimation filter 100 and the number of output latch circuits multiplied by the sample rate in the 3-phase to IQ converter 200. The conversion coefficient used by the 3-phase to IQ converter 200 has a word length of 8 bits. The sample rate of signals not down-sampled yet is 1. Furthermore, for simplification, the number of down samplers in each stage of the decimation filter 100 is equal to the word length of the output signal from the stage. The number of output latch circuits in the 3-phase to IQ converter 200 is equal to the word length of the output signal.

In FIG. 4, the word length of the output signal and the sample rate in the first decimation filter are 3 and ½, respectively. The word length of the output signal and the sample rate in the second decimation filter are 5 and ¼, respectively. The word length of the output signal and the sample rate in the third decimation filter are 7 and ⅛, respectively. The word length of the output signal and the sample rate in the fourth decimation filter are 9 and 1/16, respectively. Furthermore, the decimation filter 100 deals with 3-phase digital signals. Thus, a power consumption index for the decimation filter 100 can be evaluated to be (3×½+5×¼+7×⅛+9× 1/16)×3. Additionally, in FIG. 4, the word length of the output signal and the sample rate in the 3-phase to IQ converter 200 are 17 and 1/16, respectively. Thus, the power consumption index for the 3-phase to IQ converter 200 can be evaluated to be 17× 1/16. That is, the power consumption index for the signal processing circuit is about 13.6.

As a comparative example of the signal processing circuit in FIG. 4, a signal processing circuit is assumed which corresponds to the signal processing circuit in FIG. 4 in which the decimation filter 100 and the 3-phase to IQ converter 200 are connected together in a reverse order (that is, this signal processing circuit performs a 3-phase to IQ conversion directly on an over-sampled 3-phase digital signal). Then, the power consumption index for the signal processing circuit is similarly evaluated. The decimation filter in the comparative example is located after and connected to the 3-phase to IQ converter, and thus deals with 2-phase (orthogonal) digital signals.

In the comparative example, the word length of the output signal and the sample rate in the 3-phase to IQ converter are 9 and 1, respectively. Thus, the power consumption index for the 3-phase to IQ converter can be evaluated to be 9×1. Furthermore, in the comparative example, the word length of the output signal and the sample rate in the first decimation filter are 11 and ½, respectively. The word length of the output signal and the sample rate in the second decimation filter are 13 and ¼, respectively. The word length of the output signal and the sample rate in the third decimation filter are 15 and ⅛, respectively. The word length of the output signal and the sample rate in the fourth decimation filter are 17 and 1/16, respectively. Additionally, the decimation filter 100 deals with two-phase digital signals, and the power consumption index for the decimation filter can be evaluated to be (11×½+13×¼+15×⅛+17× 1/16)×2. That is, the power consumption index for the comparative example is about 32.4.

Thus, the power consumption of the signal processing circuit in FIG. 4 can be evaluated to be equal to or lower than the half of that of the comparative example. The sinc filter in the decimation filter includes a plurality of latch circuits and a plurality of operation circuits (adders, multipliers, and the like). Thus, the actual power consumption of the decimation filter is expected to be higher than the above-described index. That is, an actual reduction in power consumption can be expected to be larger than a difference from the above-described index.

As described above, in the signal processing circuit according to the present embodiment, the decimation filter in the signal processing circuit according to the first embodiment is configured as a CIC decimation filter. Thus, the signal processing circuit according to the present embodiment allows the signal processing circuit according to the first embodiment to be configured to have a reduced area.

### Third Embodiment

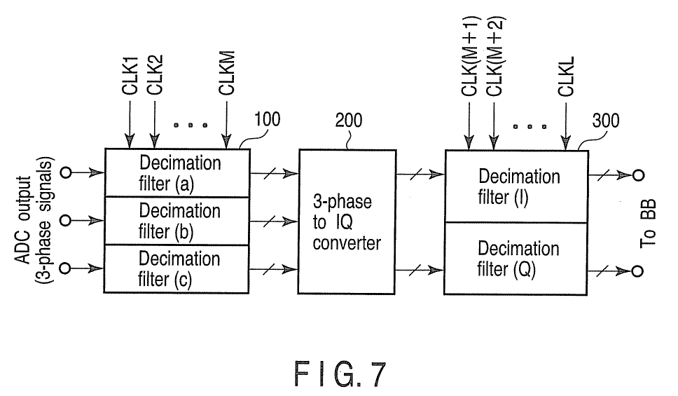

As shown in FIG. 7, a signal processing circuit according to a third embodiment of the present invention corresponds to the signal processing circuit shown in FIG. 1 described above and in which a decimation filter 300 is further provided after the 3-phase to IQ converter 200. In the description below, in FIG. 7, the same components as those in FIG. 1 are denoted by the same reference numerals. Differences from FIG. 1 will be mainly described.

The decimation filter 300 is composed of sinc filters and down samplers. A orthogonal digital signals from the 3-phase to IQ converter 200 is input to the decimation filter 300. The decimation filter 300 performs filter processing on the orthogonal digital signals to obtain orthogonal digital signals of at most a baseband frequency band. The filter processing by the decimation filter 300 reduces the sample rate of the input orthogonal digital signals (down-sampling), while increasing word length. The decimation filter 300 inputs the down-sampled orthogonal digital signals to a baseband processing unit (not shown).

For example, (L−M) (in the description below, L is a natural number larger than M) control clocks different from the above-described M control clocks CLK1, . . . , CLKM are input to the decimation filter 300. For example, the (M+1)th control clock CLK (M+1) is a pulse wave with a period 2^{M}T (that is, the pulse wave obtained by dividing the frequency of the first control clock CLK1 by 2^{M}). The Lth control clock is a pulse wave with a period 2^{L-1}T (that is, the pulse wave obtained by dividing the frequency of the first control clock CLK1 by 2^{L-1}). When the above-described control clock is applied, the decimation filter 300 performs filter processing in which the sample rate of the input orthogonal digital signal is multiplied by ½^{L-M}.

Now, the technical significance of provision of the decimation filter 300 after the 3-phase to IQ converter 200 will be described.

First, possible quantization noise from the 3-phase to IQ converter 200 in FIG. 7 and the over-sampling ADC (not shown) will be discussed.

The over-sampling ADC is assumed to be a ΔΣ ADC with a sample rate fs. When the baseband frequency is defined as fb, a sample rate of 2fb is required to restore the input signal to the ΔΣ ADC according to a sampling theorem. Thus, the over-sampling rate OSR of the ΔΣ ADC is expressed by:

$$\frac{{f}_{s}}{2 {f}_{b}} = O S R \qquad ( 15 )$$

Provided that the over-sampling ADC is a ΔΣ ADC, quantization noise is driven out to a high frequency region under a noise shaping effect. Specifically, when the one-side PSD (Power Spectral Density) of a quantizer inside a first-order ΔΣ ADC is defined as Se(f) and the one-side PSD after noise shaping is Sq(f), Expression (16) is formed.

S_{q}(f)=(2 sin(πft))²Se(f) (16)

Here, it is assumed OSR>>1. Then, the total amount (mean square error power) of quantization noise in the output signal from the ΔΣ ADC in the baseband frequency band is expressed by:

$$\begin{matrix}{q}_{rms}^{2} = {\int }_{0}^{{f}_{b}} {S}_{q} ( f ) d f \\ = {\int }_{0}^{{f}_{b}} {( 2 π ft )}^{2} Se ( f ) d f \\ = \frac{{π}^{2}}{3 {( O S R )}^{3}} \cdot {( \frac{Δ}{12} )}^{2}\end{matrix} \qquad ( 17 )$$

In Expression (17), Δ denotes the number of quantization steps (LSB: the maximum input amplitude of the quantizer/the maximum code of the quantizer) in the quantizer inside the ΔΣ ADC. On the other hand, if the quantization noise is not shaped, the total amount of quantization noise (mean square error power) in the baseband frequency band is expressed by:

$$\begin{matrix}{q}_{rms}^{2 ′} = {\int }_{0}^{{f}_{b}} {S}_{e} ( f ) d f \\ = \frac{1}{O S R} \cdot {( \frac{Δ}{12} )}^{2}\end{matrix} \qquad ( 18 )$$

Provided that the OSR in Expression (17) is equal to that in Expression (18) are equal (that is, fb in Expression (17) is equal to that in Expression (18)), the noise shaping by the ΔΣ ADC clearly reduces the total amount of quantization noise.

Furthermore, Expression (17) indicates that the down sampling by the decimation filter 100 reduces the OSR. Thus, to prevent a possible increase in the total amount of quantization error, the decimation filter 100 needs to equivalently reduce Δ. Consequently, to allow a reduction in Δ, the word length of the output signal from the decimation filter 100 is set to be larger than that of the input signal to the decimation filter 100.

Additionally, according to Expressions (17) and (18), to reduce the total amount of quantization noise from the 3-phase to IQ converter 200 so that the total amount is equivalent to that of quantization noise from the ΔΣ ADC, Δ needs to be set to be further smaller than that of the ΔΣ ADC. That is, the 3-phase to IQ converter 200 needs to provide the conversion coefficient with a word length larger than that of a 3-phase digital signal input by the decimation filter 100.

Here, for example, provided that the image rejection ratio required by the baseband processing unit (not shown) is at most about 40 db, 6 bits are sufficient for the word length of the conversion coefficient according to FIG. 5. However, if the ΔΣ ADC has a high over-sampling rate, the word length of the 3-phase digital signals input by the decimation filter 100 may exceed 6 bits. As described above, to reduce the total amount of quantization noise from the 3-phase to IQ converter 200 so that the total amount is equivalent to that of quantization noise from the ΔΣ ADC, the word length of the conversion coefficient needs to be set to be larger than that of the 3-phase digital signals input by the decimation filter 100. That is, the 3-phase to IQ converter 200 inevitably needs to provide the conversion coefficient with a word length larger than 6 bits. The circuit area and power consumption of the 3-phase to IQ converter 200 may be increased by a conversion coefficient with a word length unnecessarily larger than that which is sufficient to achieve the required image rejection ratio (in the present example, 6 bits).

In the signal processing circuit in FIG. 1 described above, the decimation filter 100 performs down sampling corresponding to the over-sampling rate of the over-sampling ADC (not shown). This is likely to increase the word length of the 3-phase digital signals input to the 3-phase to IQ converter 200. On the other hand, the signal processing circuit in FIG. 7 has the decimation filter 100 located before the 3-phase to IQ converter 200 and the decimation filter 300 located after the 3-phase to IQ converter 200. Thus, in the signal processing circuit in FIG. 7, the decimation filter 100 need not independently perform all of the down sampling corresponding to the over-sampling rate of the over-sampling ADC (not shown). The decimation filter 100 can share the down sampling with the decimation filter 300. Specifically, the decimation filter 100 performs the down sampling to the extent that the word length of the output signal from the filter is not larger than that to be provided to the conversion coefficient by the 3-phase to IQ converter 200 (that is, the word length sufficient to achieve the required image rejection ratio). Then, the 3-phase to IQ converter 200 uses the conversion coefficient with the set word length to perform a 3-phase to IQ conversion. Finally, the decimation filter 300 performs the rest of the down sampling.

As described above, the signal processing circuit according to the present embodiment has the different decimation filters arranged before and after the 3-phase to IQ converter, respectively. The decimation filter located before the 3-phase to IQ converter performs down sampling to the extent that the word length of the output signal from the filter is not larger than that to be provided to the conversion coefficient by the 3-phase to IQ converter. Then, the 3-phase to IQ converter uses the conversion coefficient with the set word length to perform a 3-phase to IQ conversion. The decimation filter located after the 3-phase to IQ converter performs the rest of the down sampling. Thus, the signal processing circuit according to the present embodiment has only to set the minimum required word length for the conversion coefficient used by the 3-phase to IQ converter. Therefore, the signal processing circuit can be configured to have reduced power consumption and a reduced area.

### Fourth Embodiment

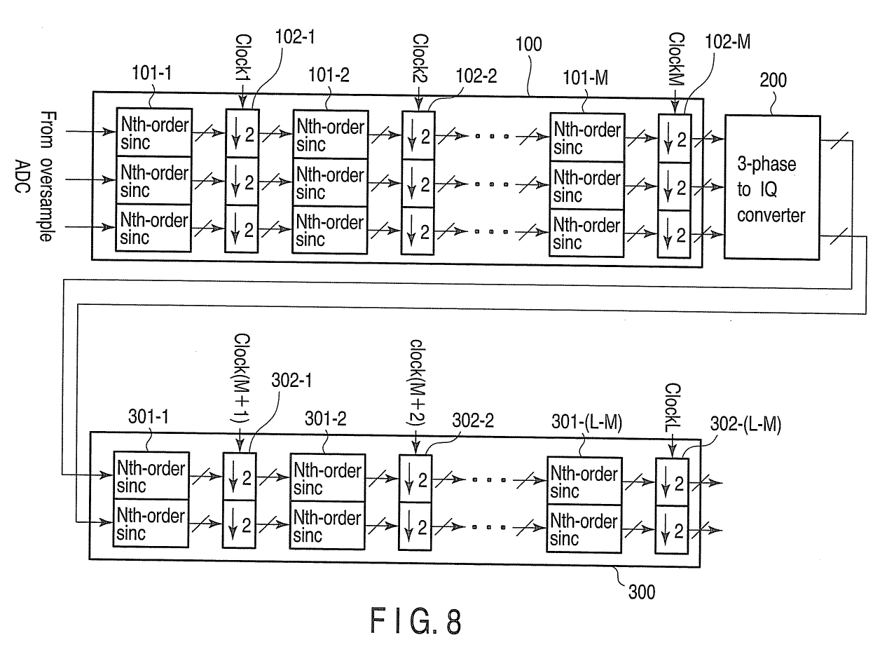

As shown in FIG. 8, a signal processing circuit according to a fourth embodiment of the present invention corresponds to the signal processing circuit shown in FIG. 7 described above and in which each of the decimation filters 100 and 300 is composed of a plurality of cascaded decimation filters with a low down sample rate. In the description below, in FIG. 8, the same components as those in FIG. 7 are denoted by the same reference numerals. Differences from FIG. 7 will be mainly described.

In FIG. 8, the decimation filter 100 is composed of M decimation filters each composed of an Nth-order sinc filter and a down sampler, M decimation filters begin cascaded together, as in the case of FIG. 3. Furthermore, in FIG. 8, the decimation filter 300 is composed of (L−M) decimation filters each composed of an Nth-order sinc filter and a down sampler, (L−M) decimation filters being cascaded together. Thus configuring the decimation filters 100 and 300 as CIC decimation filters can be expected to reduce the circuit area.

As described above, in the signal processing circuit according to the present embodiment, the decimation filters in the signal processing circuit according to the third embodiment are configured as CIC decimation filters. Thus, the signal processing circuit according to the present embodiment allows the signal processing circuit according to the third embodiment to be configured to have a further reduced area.

### Fifth Embodiment

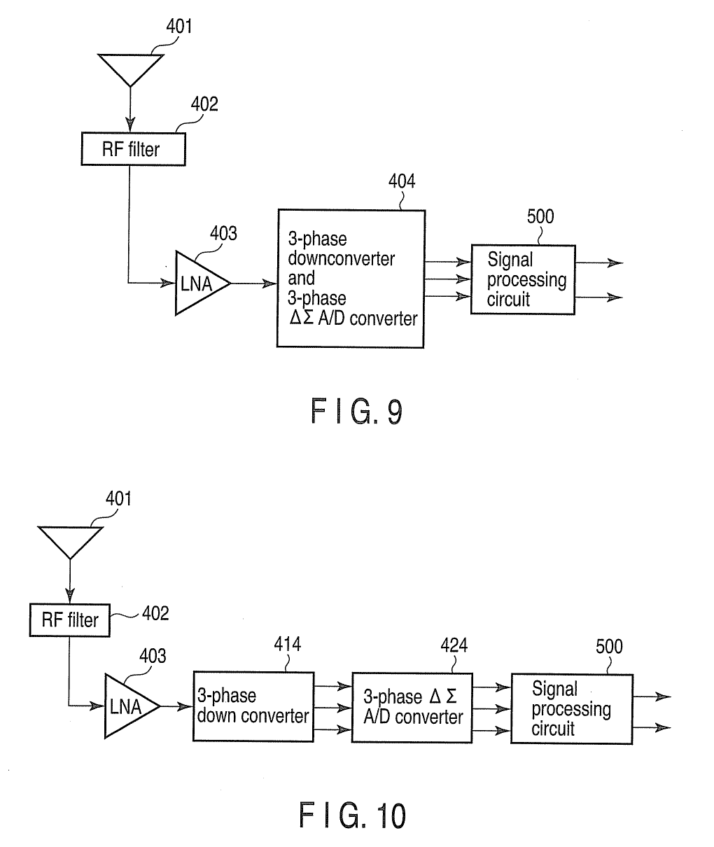

As shown in FIG. 9, a receiver according to a fifth embodiment of the present invention includes an antenna 401, an RF filter 402, an LNA (Low Noise Amplifier) 403, a 3-phase down converter and 3-phase ΔΣ sigma ADC 404, and a signal processing circuit 500.

The antenna 401 receives a signal propagating through a space and inputs the signal to the RF filter 402. The RF filter 402 performs filter processing for inhibiting the signal components of the signal from the antenna 401 other than a frequency to be received. The RF filter 402 then inputs the resulting signal to LNA 403. LNA 403 amplifies the signal from the RF filter 402, and inputs the amplified signal to the 3-phase down converter and 3-phase ΔΣ ADC 404.

The 3-phase down converter and 3-phase ΔΣ ADC 404 multiplies the signal from the LNA 403 by a 3-phase local signal to obtain a 3-phase analog signal in the baseband frequency band. Moreover, the 3-phase down converter and 3-phase ΔΣ ADC 404 samples the 3-phase analog signal at a sample rate higher than the baseband frequency. The 3-phase down converter and 3-phase ΔΣ ADC 404 then quantizes the signal (subjects the signal to an analog-digital conversion) to obtain 3-phase digital signals. The 3-phase down converter and 3-phase ΔΣ ADC 404 then inputs the 3-phase digital signals to the signal processing circuit 500.

The signal processing circuit 500 is composed of the signal processing circuit according to one of the above-described first to fourth embodiments. In response to the 3-phase digital signals from the 3-phase down converter and 3-phase ΔΣ ADC 404, the signal processing circuit 500 performs the above-described down sampling and 3-phase to IQ conversion to generate orthogonal signals in the baseband frequency band. The baseband processing unit (not shown) performs various processes such as decoding on the orthogonal signals.

As described above, the receiver according to the present embodiment uses the signal processing circuit according to one of the above-described first to fourth embodiments. Thus, the receiver according to the present embodiment enables a reduction in power consumption associated with the 3-phase to IQ conversion and down sampling.

### Sixth Embodiment

As shown in FIG. 10, a receiver according to a sixth embodiment of the present invention corresponds to the receiver shown in FIG. 9 described above and in which the 3-phase down converter and 3-phase ΔΣ ADC 404 is replaced with a 3-phase down converter 414 and a 3-phase ΔΣ ADC 424. In the description below, in FIG. 10, the same components as those in FIG. 9 are denoted by the same reference numerals. Differences from FIG. 9 will be mainly described.

The 3-phase down converter 414 multiplies a signal from LNA 403 by a 3-phase local signal to obtain 3-phase analog signals in the baseband frequency band.

The 3-phase down converter 414 inputs the 3-phase analog signals to the 3-phase ΔΣ ADC 424.

The 3-phase ΔΣ ADC 424 samples the 3-phase analog signals from the 3-phase down converter 414 at a sample rate higher than the baseband frequency. The 3-phase ΔΣ ADC 424 quantizes the signal (subjects the signal to an analog-digital conversion) to obtain 3-phase digital signals. The 3-phase ΔΣ ADC 424 inputs the 3-phase digital signals to the signal processing circuit 500.

As described above, the receiver according to the present embodiment uses the signal processing circuit according to one of the above-described first to fourth embodiments. Thus, the receiver according to the present embodiment enables a reduction in power consumption associated with the 3-phase to IQ conversion and down sampling.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A signal processing circuit comprising:
a decimation filter which down-samples over-sampled first three-phase digital signals to obtain second three-phase digital signals; and
a converter which subjects the second three-phase digital signals to a three-phase to IQ conversion, and obtains orthogonal digital signals.

2. The circuit according to claim 1, wherein the decimation filter is a CIC decimation filter.

3. The circuit according to claim 1, wherein the decimation filter comprises a plurality of pairs of a sinc filter and a down sampler which are cascaded.

4. The circuit according to claim 1, wherein the second three-phase digital signals are in a baseband frequency band.

5. A receiver comprising:
a three-phase downconverter which down-converts a received radio signal to obtain three-phase analog signals in a baseband frequency band;
an analog-to-digital converter which subjects the three-phase analog signals to an analog-digital conversion at a sample rate higher than the baseband frequency band to obtain the first three-phase digital signals; and
the circuit according to claim 1.

6. A signal processing circuit comprising:
a first decimation filter which down-samples over-sampled first three-phase digital signals to obtain second three-phase digital signals;
a converter which subjects the second three-phase digital signals to a three-phase to IQ conversion and obtains first orthogonal digital signals; and
a second decimation filter which down-samples the first orthogonal digital signal to obtain second orthogonal digital signals.

7. The circuit according to claim 6, wherein at least one of the first decimation filter and the second decimation filter is a CIC decimation filter.

8. The circuit according to claim 6, wherein at least one of the first decimation filter and the second decimation filter comprises a plurality of pairs of a sinc filter and a down sampler which are cascaded.

9. The circuit according to claim 6, wherein the second orthogonal digital signals are in a baseband frequency band.

10. A receiver comprising:
a three-phase downconverter which down-converts a received radio signal to obtain three-phase analog signals in a baseband frequency band;
an analog-to-digital converter which subjects the three-phase analog signals to an analog-digital conversion at a sample rate higher than the baseband frequency band to obtain the first three-phase digital signals; and
the circuit according to claim 6.
